(19) United States
(12) Patent Application Publication
(10) Pub. No.: US 2025/0217007 A1
(43) Pub. Date: Jul. 3, 2025

(54) USER GROUP GENERATION

(71) Applicant: NETEASE (HANGZHOU) NETWORK CO., LTD., Hangzhou (CN)

(72) Inventor: Xin LI, Hangzhou (CN)

(21) Appl. No.: 18/875,275

(22) PCT Filed: Oct. 27, 2022
(86) PCT No.: PCT/CN2022/128044

§ 371 Date: Dec. 16, 2024

(30) Foreign Application Priority Data
Jun. 24, 2022 (CN) 202210730338.7

(51) Int. Cl. G06F 3/0482; G06F 3/0485; G06F 3/0488; H04L 51/04

(52) U.S. Cl. CPC G06F 3/0482; G06F 3/0485; G06F 3/0488; H04L 51/04

(57) ABSTRACT

The present disclosure provides a method for generating a user group. The method includes: setting a user ID to be in an interactive state in response to the user ID and a keyword appearing in a session record; determining a target member of a target user group and displaying a create control in response to a first touch operation on the user ID; and creating the target user group including the target member in response to a second touch operation on the create control.

### CROSS-REFERENCE TO RELATED APPLICATIONS

The present disclosure is a 371 national phase application of PCT Application No. PCT/CN2022/128044 filed Oct. 27, 2022, which claims priority to Chinese patent application No. 202210730338.7 filed on Jun. 24, 2022 and entitled “METHOD AND APPARATUS FOR GENERATING USER GROUP, AND ELECTRONIC DEVICE”, the entire contents of both of which applications are hereby incorporated by reference for all purposes.

### TECHNICAL FIELD

The present disclosure relates to the technical field of data processing, and in particular relates to a method and apparatus for generating a user group, and an electronic device.

### BACKGROUND

In chat tools, creating a group and inviting a person to join a group are commonly used functions by users. In the related art, if a new group is to be created, a user needs to exit the current session, tap a Create Group button, and then select a target person from a friend list to create the new group; and if a person needs to be invited to join a group, the user needs to tap an Invite Member button in the group, select the person's name of a target user from a friend list, and confirm the selection to invite the person to join the group. The above method for creating a group and inviting a person to join a group has a long process, requires repeated switching between sessions, and is complicated in operation, affecting the user experience.

### SUMMARY

According to a first aspect, the present disclosure provides a method for generating a user group. The method includes: setting, in response to a user ID and a keyword appearing in a session record of a current user group, the user ID to be in an interactive state, where the session record of the current user group is displayed in a session window within a graphic user interface of a terminal device, and the keyword indicates an intent to generate a target user group related to the user ID; determining, in response to a first touch operation on the user ID, a target member of the target user group, where the target member of the target user group include a user matching the user ID; displaying a create control; and creating the target user group including the target member in response to a second touch operation on the create control.

According to a second aspect, the present disclosure provides a system, comprising one or more memories collectively containing one or more programs, and one or more processors, where the one or more processors are configured to, individually or collectively, perform the operations in the above method for generating a user group.

According to a third aspect, the present disclosure provides one or more non-transitory computer-readable storage media containing, in any combination, computer program code that, when executed by a computer system, performs the operations in the above method for generating a user group.

### BRIEF DESCRIPTION OF THE DRAWINGS

FIG. 1 is a flowchart of a method for generating a user group provided in an embodiment of the present disclosure;

FIG. 2 is a flowchart of another method for generating a user group provided in an embodiment of the present disclosure;

FIG. 3 is a schematic diagram of creating a new user group provided in an embodiment of the present disclosure;

FIG. 4 is a schematic diagram of inviting a user to join an existing user group provided in an embodiment of the present disclosure;

FIG. 5 is a flowchart of another method for generating a user group provided in an embodiment of the present disclosure;

FIG. 6 is a flowchart of another method for generating a user group provided in an embodiment of the present disclosure;

FIG. 7 is a schematic structural diagram of an apparatus for generating a user group provided in an embodiment of the present disclosure; and

FIG. 8 is a schematic structural diagram of an electronic device provided in an embodiment of the present disclosure.

### DETAILED DESCRIPTION

To make the objectives, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are only part of the embodiments of the present disclosure, not all of the embodiments. Typically, the components in the embodiments of the present disclosure described and illustrated in the drawings herein may be arranged and designed in many different configurations.

Therefore, the following detailed description of the embodiments of the present disclosure provided in the accompanying drawings is not intended to limit the scope of the present disclosure as claimed, but is merely representative of selected embodiments of the present disclosure. Based on the embodiments in the present disclosure, all other embodiments obtained by those of ordinary skill in the art without making any creative work shall fall within the scope of protection of the present disclosure.

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

The method, apparatus, and electronic device for generating a user group provided by the present disclosure operate as follows: set a user ID to be in an interactive state in response to the user ID and a keyword appearing in a session record of a current user group, where the session record of the current user group is displayed in a session window within a graphic user interface of a terminal device, and the keyword indicates an intent to generate a target user group related to the user ID; determine one or more target members of the target user group in response to a first touch operation on the user ID, where the one or more target members of the target user group comprise a user corresponding to the user ID; display a create control; and create the target user group comprising the one or more target members in response to a second touch operation on the create control. Through the disclosed method, a user corresponding to a user ID can be invited to a new user group, or the user can be invited to join the current user group based on the user ID and a specified keyword appearing in a session record displayed in the current session window. This eliminates the need for repeatedly switching between sessions and removes the need for manual searches to find users. The method enables quick matching with a user ID, making group creating simple and efficient while improving the overall user experience.

Other features and advantages of the present disclosure will be set forth in the following description, or some features and advantages may be inferred or unambiguously determined from the description or may be learned by implementing the aforementioned technology of the present disclosure.

To make the aforementioned objectives, features and advantages of the present disclosure clearer and easier to understand, preferred implementations are specifically listed below and described in detail with reference to the accompanying drawings.

In chat tools, creating a group and inviting a person to join a group are commonly used functions by users. In the related art, a key person's name may be mentioned in a chat, and the dialogues are to invite someone to join a group, and to create a group with someone for discussion. At this time, the person needs to be manually searched and invited to join the group. Specifically, if a new group is to be created, a user needs to exit the current session, tap a Create Group button, and then select a target person from a friend list to create the new group; and if the person needs to be invited to join a group, the user needs to tap an Invite Member button in the group, select the person's name of the target user from a friend list, and confirm the selection to invite the person to join the group. However, the above method for creating a group and inviting a person to join a group has a long process, requires repeated switching between sessions, and is complicated in operation, affecting the user experience.

Based on the above, the embodiments of the present disclosure provide a method and apparatus for generating a user group, and an electronic device, and the technology can be applied to a scenario of inviting a person to join a group or creating a new group.

A method for generating a user group in an embodiment of the present disclosure may be run on a terminal device or a server. The terminal device may be a local terminal device for interaction with a user via a graphical user interface. The local terminal device may provide the graphical user interface to the user in many forms, for example, the graphical user interface may be rendered and displayed on a display screen of the terminal, or provided to a player via holographic projection. For example, the local terminal device may include a display screen and a processor, where the display screen is used for presenting a graphical user interface. When the method for generating a user group is run on a server, the method may be implemented and executed based on a cloud interaction system, where the cloud interaction system includes a server and a client device.

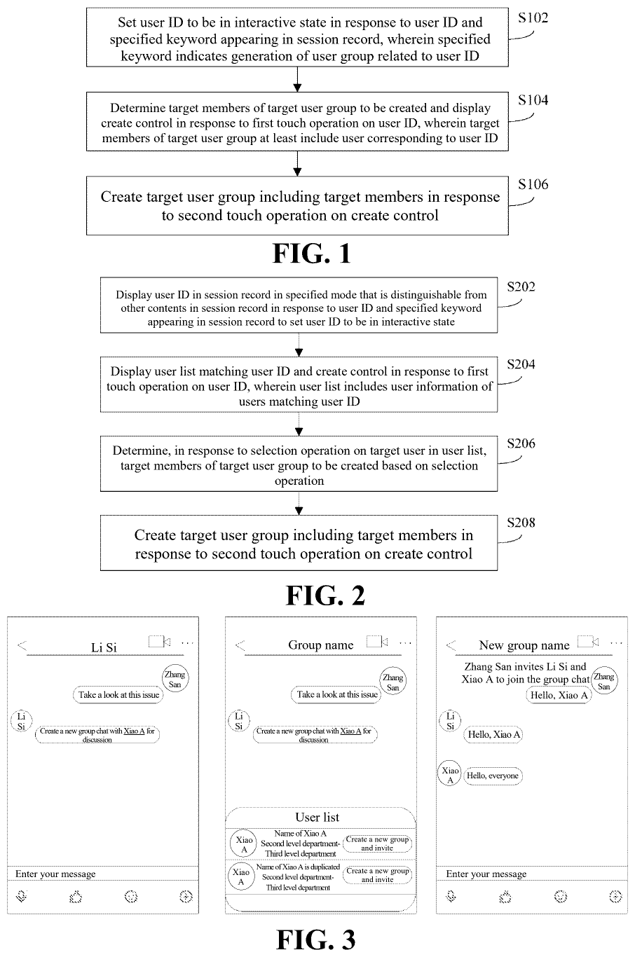

An embodiment of the present disclosure provides a method for generating a user group, where a graphical user interface is provided via a terminal device, the graphical user interface includes a session window, and the session window displays a session record of users in the current user group; as shown in FIG. 1, the method including the following specific steps:

S102: a user ID is set to be in an interactive state in response to the user ID and a specified keyword appearing in the session record, where the specified keyword indicates generation of a user group related to the user ID.

The session window included in the graphical user interface is typically a window for users in the current user group to chat. The session window includes session records (i.e., chat logs), and each session record corresponds to a session user. In some embodiments, the session window corresponding to the current user group may be a private chat window including two users, or may be a group chat window corresponding to a certain group.

Specifically, the user ID may be the user's name, nickname, email address, work account, or the like, which is not specifically limited here. The specified keyword is typically a word and phrase related to generation of the user group of the user ID, and may be a word and phrase related to creation of a new user group, or a word and phrase related to inviting a person to join a certain user group. For example, the specified keyword may be “join the group”, “invite to join the group”, “create a new group”, or “create another group”.

In some embodiments, whether the user ID and the specified keyword appear in the current session record may be recognized by voice recognition technology or text recognition technology. If the user ID and the specified keyword appear in the current session record, the user ID is immediately set to be in an interactive state; and the user can touch the user ID in the interactive state to determine the target members of the target user group to be created.

S104: target members of a target user group to be created are determined and a create control is displayed in response to a first touch operation on the user ID, where the target members of the target user group at least include a user corresponding to the user ID.

The first touch operation on the user ID may be a tap operation, a swipe operation or a drag operation on the user ID, which is not specifically limited here. When the user performs the first touch operation on the user ID, the target user matching the user ID is determined as the target member, and the create control is displayed. The create control may be provided in a manner that one create control corresponds to one target member, or only one create control may be displayed. Specifically, all target users matching the user ID may be determined as the target members, or one or more users may be selected from the target users as the target members as required. In some embodiments, not only the target users matching the user ID may be determined as the target members, but also the users in the current user group may be determined as the target members.

S106: the target user group including the target members is created in response to a second touch operation on the create control.

The second touch operation on the create control may be a tap operation, a swipe operation or a drag operation on the create control, which is not specifically limited here. In some embodiments, if one target user corresponds to one create control, the target user may be determined as a target member and a target user group including the target member may be created by touching the create control; and if only one create control is displayed, a target user group including the determined target member may be created by touching the create control.

In practical applications, the current user group includes two members or more than three members. If the current user group includes two members, the current user group is a private chat session. If the current user group includes three or more members, the current user group is a group chat session.

In some embodiments, the user corresponding to the user ID and the members in the current user group are determined as the target members in response to the first touch operation on the user ID; and then the user corresponding to the user ID is invited to join the current user group to obtain the target user group including the target members in response to a second touch operation on the create control; or a new target user group including the target members is created in response to a second touch operation on the create control. By the method, creating a group and inviting a person to join a group in a session chat can be quickly completed. The method can help a user quickly match a user to be invited without manual search and invitation. The method is quick in operation and reduces switching in creating a new user group and inviting a person to join a group in the related art.

According to the method for generating a user group provided by the present disclosure, first, a user ID is set to be in an interactive state in response to the user ID and a specified keyword appearing in the session record, where the specified keyword indicates generation of a user group related to the user ID; then, target members of a target user group to be created are determined and a create control is displayed in response to a first touch operation on the user ID, where the target members of the target user group at least include a user corresponding to the user ID; and then, the target user group including the target members is created in response to a second touch operation on the create control. By the method, a user corresponding to a user ID can be invited and a new user group can be created or the user can be invited to join the current user group based on the user ID and a specified keyword appearing in a session record in the current session window, so that a new user group can be created or a user can be invited to join a user group without repeatedly switching between sessions. Also, the method does not require manual search for a user, and a user can be quickly matched with a user ID, making the operation for generating a user group quick and simple, and helping improve the user experience.

An embodiment of the present disclosure further provides another method for generating a user group, which is implemented based on the above embodiment. The method focuses on describing the specific process of setting a user ID to be in an interactive state in response to the user ID and a specified keyword appearing in the session record (implemented by the following S202), and the specific process of determining target members of a target user group to be created and displaying a create control in response to a first touch operation on the user ID (implemented by the following S204 to S206). As shown in FIG. 2, the method includes the following specific steps:

S202: the user ID is displayed in the session record in a specified mode that is distinguishable from other contents in the session record in response to the user ID and the specified keyword appearing in the session record, such that the user ID is set to be in an interactive state.

In some embodiments, the specified mode may be set according to research and development requirements. Specifically, the specified mode includes at least one of the following: a highlighting display mode; a display mode of a target color; and an underlining display mode. The target color may be set according to research and development requirements. For example, the target color may be red, yellow or green.

S204: a user list matching the user ID and a create control are displayed in response to the first touch operation on the user ID, where the user list includes user information of users matching the user ID.

When the user touches the user ID, the user list pops up immediately on the session window (the user list is typically not displayed in the session window, but a new window, i.e., a new layer, pops up). The user list includes the user information of the user matching the user ID, and the user information may include the user name, department of the user, user nickname, and the like. The create control may be displayed in the user list or in a location outside the user list in the graphical user interface.

In some embodiments, S204 may also be implemented in the following manner: a preset database is searched for users matching the user ID and the found users are displayed in the user list in response to the first touch operation on the user ID, where the preset database contains user IDs and user information of users related to the users in the current user group. The user related to the user in the current user group may be a user in the same company, department or team as the user in the current user group, or may be a friend in a friend list of the user in the current user group.

In some embodiments, the user ID that appears in the session record of the current user group is typically a user ID contained in a preset database. When a user ID contained in a preset database and the specified keyword appear in the session record, the user ID may be set to be in an interactive state. Whether the session record includes the user ID contained in the preset database may be recognized by intelligent comparison, semantic recognition, or other technologies. Then, the user performs a touch operation (e.g., a tap operation or a drag operation) on the user ID, and the user list displaying users that are found from the preset database and match the user ID pops up.

Specifically, the specific process of searching a preset database for users matching the user ID and displaying the found users in the user list includes: a preset database is searched for users matching the user ID to obtain multiple matching users; the matching users are sorted according to the degree of matching between the matching users and the user corresponding to the session record; and the matching users are displayed in the user list based on the sorting result. The user corresponding to the session record is also the user of the user ID and the specified keyword involved in the session record. The matching degree may be understood as intimacy or association. Typically, the matching users may be sorted in a descending order of matching degrees to obtain the sorting result, so that the user can quickly find the desired member from the user list.

S206: in response to a selection operation on a target user in the user list, the target members of a target user group to be created are determined based on the selection operation.

The selection operation on the target user in the user list may be an operation of the user tapping on the user information in the user list, and determining the user corresponding to the tapped user information as the target member. The selection operation may also be an operation of triggering a selection control corresponding to certain user information in the user list, and determining the user corresponding to the triggered selection control as the target member.

In some embodiments, some or all users in the current user group corresponding to the session record may be determined as the target members by default.

S208: the target user group including the target members is created in response to a second touch operation on the create control.

In some embodiments, if the current user group is a private chat session, after the target member is selected from the user list, a new target user group including the target member and the two users in the current user group is created by touching the create control. If the current user group is a group chat session, after the target member is selected from the user list, the target member is invited to join the current user group by touching the create control. The current user group after the target member is invited to join the group is also the target user group.

In some embodiments, the user list may also be understood as a control panel containing user information of users. A user may be selected by triggering the user in the control panel, and a user group including the user may be generated after the user is selected. If the session window corresponding to the current user group is a private chat window, the target user group created is a new user group including the selected user and the users corresponding to the current user group. If the current user group is a group, the target user group created is still the current user group, but the selected user is invited to join the current user group so that the current user group includes the selected user.

In one embodiment, the user list includes user information of users matching the user ID and invite controls corresponding to the respective users. The specific implementation of S206 to S208 may be: a target user group including the target user and the users in the current user group is created in response to a trigger operation on the invite control corresponding to the target user in the user list.

The invite control may be a control corresponding to a user for creating a new group and inviting the user. The user corresponding to a first control may be invited and the new user group may be created via the invite control. As shown in FIG. 3, a schematic diagram of creating a new user group is provided. In a private chat window of Zhang San and Li Si displayed in a session window in FIG. 3, a session record of Li Si is “Create a new group with Xiao A for discussion”. Since “Xiao A” in the session record is recognized as a user ID and “Create a new group” is recognized as a specified keyword, “Xiao A” is underlined in the session record at this moment (as shown in the left figure in FIG. 3) to set “Xiao A” to be in an interactive state in the session record. As shown in the middle figure in FIG. 3, a user list pops up in the session record by tapping “Xiao A”. Then, multiple users with a duplicate name may be displayed, so the users matching the user ID need to be displayed in the user list in a descending order of matching degrees. Each user in the user list also corresponds to a “Create a new group and invite” control (equivalent to the aforementioned invite control). After the “Create a new group and invite” control corresponding to a target user is tapped, Zhang San and Li Si corresponding to the private chat window and the target user can be invited to join a newly created group for chatting. The right figure in FIG. 3 is the session window corresponding to the newly created group.

In some embodiments, if multiple user IDs are recognized in the session record, indicating that the user wants to invite multiple persons simultaneously and create a new group chat, the users corresponding to the multiple user IDs may be displayed in the pop-up user list. In the user list, the users corresponding to the multiple user IDs may be displayed simultaneously in one name card, and one name card corresponds to one invite control. For a duplicate name, multiple name cards may be displayed by combination, such that each name card includes the user corresponding to each of the multiple user IDs, but each name card includes at least one different user. Then, the invite control corresponding to the users to be invited may be tapped to invite multiple users in the name card corresponding to the invite control and create a new group chat simultaneously.

In the user list, one name card may only display one user, and one user corresponds to one invite control (the user list in FIG. 3 is in such a form that one name card corresponds to one user and one invite control). Then, the user taps multiple invite controls to invite the users corresponding to the multiple invite controls and create a new group chat simultaneously.

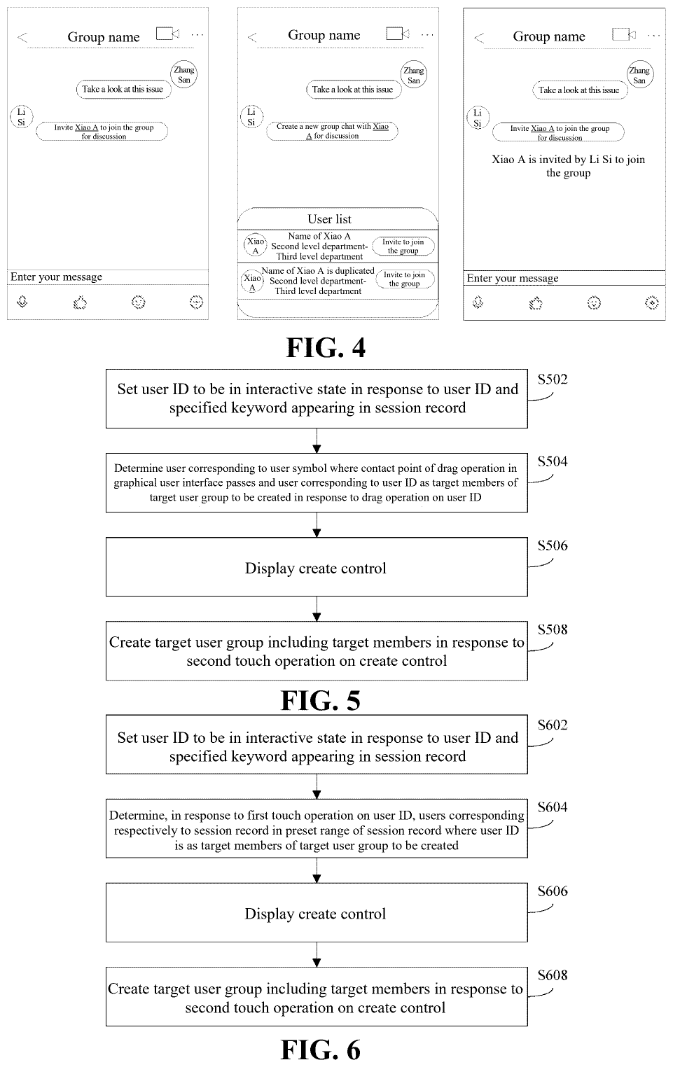

The invite control may also be a control corresponding to a user and used for inviting the user to a group. The user corresponding to the invite control may be invited to join the current user group via the invite control. As shown in FIG. 4, a schematic diagram of inviting a user to join an existing user group is provided. In a group chat window of Zhang San and Li Si displayed in a session window in FIG. 4, a session record of Li Si is “Invite Xiao A to join the group for discussion”. Since “Xiao A” in the session record is recognized as a user ID and “Invite to join the group” is recognized as a specified keyword, “Xiao A” is underlined in the session record (as shown in the left figure in FIG. 4) to set “Xiao A” to be in an interactive state in the session record. As shown in the middle figure in FIG. 4, a user list pops up in the session record by tapping “Xiao A”. Then, multiple users with a duplicate name may be displayed, so the users matching “Xiao A” need to be displayed in the user list in a descending order of matching degrees. Each user in the user list also corresponds to an “Invite to join the group” control (equivalent to the aforementioned invite control). After the “Invite to join the group” control corresponding to a target user is tapped, the target user can be invited to join the current session group of Zhang San and Li Si for chatting. The right figure in FIG. 4 is the session window corresponding to the group after Xiao A is invited to join the group.

In some embodiments, if multiple user IDs are recognized in the session record, suggesting that the user wants to invite multiple persons simultaneously to join the current group (equivalent to the current user group), the users corresponding to the multiple user IDs may be displayed in the pop-up user list. In the user list, the users corresponding to the multiple user IDs may be displayed simultaneously in one name card, and one name card corresponds to one invite control. For a duplicate name, multiple name cards may be displayed by combination, such that each name card includes the user corresponding to each of the multiple user IDs, but each name card includes at least one different user. Then, the invite control corresponding to the users to be invited may be tapped to invite multiple users in the name card corresponding to the invite control to join the current group.

In the user list, one name card may only display one user, and one user corresponds to a second control (the user list in FIG. 4 is in such a form that one name card corresponds to one user and one invite control). Then, the user taps multiple invite controls to invite the users corresponding to the multiple invite controls to join the current group simultaneously. In some embodiments, when a user is invited to join the current group, the permission setting of the current group needs to be determined. If the group sets permission for applying to join the group, approval needs to be applied before the target user is invited to join the group. If the group does not set permission, the target user can be directly invited to join the current group by the above method.

By the method for generating a user group, a user ID can be set to be in an interactive state in the current session window based on the user ID and a specified keyword appearing in a session record, and then the user ID may be touched to invite the user corresponding to the user ID and create a target user group. The method does not require manual search for a user, and a user can be quickly matched with a user ID, making the operation for generating a user group quick and simple, and helping improve the user experience.

An embodiment of the present disclosure further provides another method for generating a user group, which is implemented based on the above embodiment. The method focuses on describing the specific process of determining target members of a target user group to be created in response to a first touch operation on the user ID (implemented by the following S504). As shown in FIG. 5, the method includes the following specific steps:

S502: a user ID is set to be in an interactive state in response to the user ID and a specified keyword appearing in the session record.

S504: a user corresponding to a user symbol where a contact point of a drag operation in the graphical user interface passes and the user corresponding to the user ID are determined as target members of the target user group to be created in response to the drag operation on the user ID.

The user symbol may be a user name, user avatar, user nickname, or the like displayed in the user interface. For example, the user corresponding to a user avatar where the contact point of the drag operation in the graphical user interface passes in the session record and the user corresponding to the user ID may be determined as target members. In some embodiments, S504 may be implemented by the following steps 10-11:

Step 10: a user corresponding to a user symbol where a contact point of a drag operation in the graphical user interface passes is determined in response to the drag operation on the user ID.

Step 11, the user corresponding to the user symbol where the contact point of the drag operation in the graphical user interface passes and the user corresponding to the user ID are determined as target members of the target user group to be created in response to the end of the drag operation.

In some embodiments, if there are multiple users matching the user ID, a user list may pop up at the end of the drag operation, target users matching the user ID may be displayed in the user list, and the users in the user list may be selected to determine the selected users as partial members of target members.

In practical applications, the session record in the session window is controlled to scroll when the touch point of the drag operation in the graphical user interface reaches an edge of the session window. The session record scrolling in the session window makes it convenient for the user to select target members from the session record.

S506: a create control is displayed.

In some embodiments, the create control may be displayed in the graphical user interface after the target members are determined, or the create control may be displayed when the user ID is dragged.

S508: the target user group including the target members is created in response to a second touch operation on the create control.

By the method for generating a user group, a user group can be quickly created in a session chat. The method can help a user quickly match a user to be invited without manual search and invitation. The method is quick in operation and reduces switching in creating a new user group and inviting a person to join a group in the related art.

An embodiment of the present disclosure further provides another method for generating a user group, which is implemented based on the above embodiment. The method focuses on describing the specific process of determining target members of a target user group to be created in response to a first touch operation on the user ID (implemented by the following S604). As shown in FIG. 6, the method includes the following specific steps:

S602: a user ID is set to be in an interactive state in response to the user ID and a specified keyword appearing in the session record.

S604: users corresponding respectively to a session record in a preset range of the session record where the user ID is are determined as target members of the target user group to be created in response to the first touch operation on the user ID.

The preset range may be the session range currently displayed in the graphical user interface in the session record. The preset range may also be the session content at a specified position in the session record, or may be the last dozens of or less session contents in the session record, which is not specifically limited here and can be set according to research and development needs.

S606: a create control is displayed.

In some embodiments, the create control may be displayed in the graphical user interface after the target members are determined, or the create control may be displayed when a first trigger operation is performed on the user ID.

S608: the target user group including the target members is created in response to a second touch operation on the create control.

In some embodiments, modified target members may also be obtained in response to a modification operation on the determined target members; and then the target user group including the modified target members is created in response to a second touch operation on the create control. The method provides a function of modifying target members, allowing a user to invite a person to a user group or create a new group according to needs, and improving the user experience.

By the method for generating a user group, a new user group can be created and a person can be invited to join a user group without repeatedly switching between sessions. Also, the method does not require manual search for a user, and a user can be quickly matched with a user ID, making the operation for generating a user group quick and simple, and helping improve the user experience.

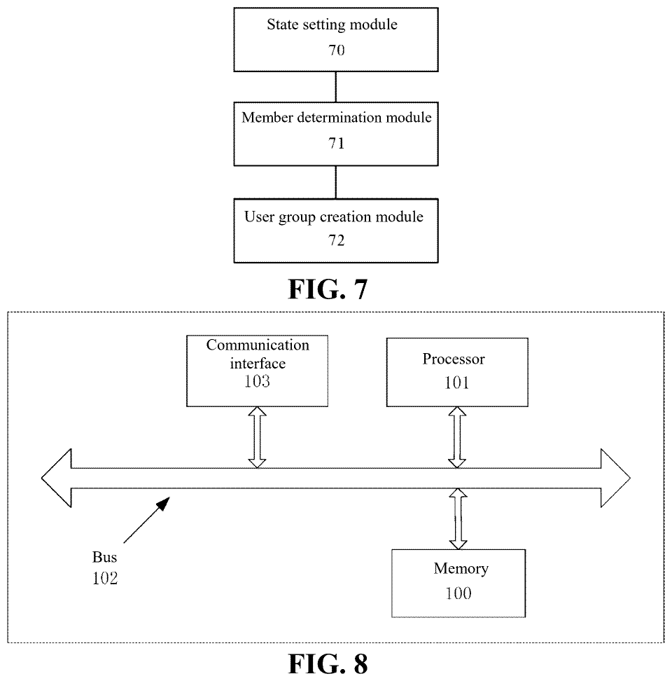

Corresponding to the method embodiment, an embodiment of the present disclosure provides an apparatus for generating a user group, where a graphical user interface is provided via a terminal device, the graphical user interface includes a session window, and the session window displays a session record of users in the current user group; as shown in FIG. 7, the apparatus includes:
a state setting module 70, configured to set a user ID to be in an interactive state in response to the user ID and a specified keyword appearing in the session record, where the specified keyword indicates generation of a user group related to the user ID;
a member determination module 71, configured to determine target members of a target user group to be created and display a create control in response to a first touch operation on the user ID, where the target members of the target user group at least include a user corresponding to the user ID; and
a user group creation module 72, configured to create the target user group including the target members in response to a second touch operation on the create control.

According to the apparatus for generating a user group, first, a user ID is set to be in an interactive state in response to the user ID and a specified keyword appearing in the session record, where the specified keyword indicates generation of a user group related to the user ID; then, target members of a target user group to be created are determined and a create control is displayed in response to a first touch operation on the user ID, where the target members of the target user group at least include a user corresponding to the user ID; and then, the target user group including the target members is created in response to a second touch operation on the create control. By the method, a user corresponding to a user ID can be invited and a new user group can be created or the user can be invited to join the current user group based on the user ID and a specified keyword appearing in a session record in the current session window, so that a new user group can be created or a user can be invited to join a user group without repeatedly switching between sessions. Also, the method does not require manual search for a user, and a user can be quickly matched with a user ID, making the operation for generating a user group quick and simple, and helping improve the user experience.

Specifically, the member determination module 71 is further configured to: display a user list matching the user ID and the create control in response to the first touch operation on the user ID, where the user list includes user information of users matching the user ID; and determine, in response to a selection operation on a target user in the user list, the target members of a target user group to be created based on the selection operation.

Further, the state setting module 70 is configured to: display the user ID in the session record in a specified mode that is distinguishable from other contents in the session record in response to the user ID and the specified keyword appearing in the session record.

In some embodiments, the specified mode includes at least one of the following: a highlighting display mode; a display mode of a target color; and an underlining display mode.

Specifically, the member determination module 71 is further configured to: search a preset database for users matching the user ID and display the found users in the user list in response to the first touch operation on the user ID, where the preset database contains user IDs and user information of users related to the users in the current user group.

Further, the member determination module is configured to: search the preset database for users matching the user ID to obtain a plurality of matching users; sort the matching users according to the degree of matching between the matching users and the user corresponding to the session record; and display the matching users in the user list based on the sorting result.

In some embodiments, the current user group includes two members or more than three members.

Specifically, the member determination module 71 is further configured to: determine the user corresponding to the user ID and the members in the current user group as the target members in response to the first touch operation on the user ID. The user group creation module 72 is configured to: invite the user corresponding to the user ID to join the current user group to obtain the target user group including the target members in response to the second touch operation on the create control; or create a new target user group including the target members in response to the second touch operation on the create control.

In some embodiments, the first touch operation includes a drag operation, and the member determination module 71 is configured to: determine a user corresponding to a user symbol where a contact point of a drag operation in the graphical user interface passes and the user corresponding to the user ID as target members of the target user group to be created in response to the drag operation on the user ID.

Further, the member determination module 71 is configured to: determine the user corresponding to the user symbol where the contact point of the drag operation in the graphical user interface passes in response to the drag operation on the user ID; and determine the user corresponding to the user symbol where the contact point of the drag operation in the graphical user interface passes and the user corresponding to the user ID as target members of the target user group to be created in response to the end of the drag operation.

Specifically, the user symbol is a user avatar.

In some embodiments, the session record in the session window is controlled to scroll when the touch point of the drag operation in the graphical user interface reaches an edge of the session window.

Further, the member determination module 71 is configured to: determine, in response to the first touch operation on the user ID, users corresponding respectively to a session record in a preset range of the session record where the user ID is as target members of the target user group to be created.

Further, the apparatus includes a modification module, configured to: obtain modified target members in response to a modification operation on the determined target members; and the user group creation module 72 is further configured to: create the target user group including the modified target members in response to the second touch operation on the create control.

The apparatus for generating a user group provided in the embodiment of the present disclosure has the same implementation principle and technical effects as those of the aforementioned method embodiment. For the sake of brief description, for matters not mentioned in the apparatus embodiment, reference may be made to the corresponding contents in the aforementioned method embodiment.

An embodiment of the present disclosure further provides an electronic device, as shown in FIG. 8, the electronic device including a processor and a memory, where machine-executable instructions executable by the processor are stored in the memory, and the processor implements the method for generating a user group when executing the machine-executable instructions.

Specifically, a graphical user interface is provided via a terminal device, the graphical user interface includes a session window, and the session window displays a session record of users in the current user group; the method including: a user ID is set to be in an interactive state in response to the user ID and a specified keyword appearing in the session record, where the specified keyword indicates an intent to generate a user group related to the user ID; one or more target members of a target user group are determined and a create control is displayed in response to a first touch operation on the user ID, where the target members of the target user group at least include a user corresponding to the user ID; and the target user group including the target members is created in response to a second touch operation on the create control.

By the method for generating a user group, a user corresponding to a user ID can be invited and a new user group can be created or the user can be invited to join the current user group based on the user ID and a specified keyword appearing in a session record in the current session window, so that a new user group can be created or a user can be invited to join a user group without repeatedly switching between sessions. Also, the method does not require manual search for a user, and a user can be quickly matched with a user ID, making the operation for generating a user group quick and simple, and helping improve the user experience.

In one embodiment, the determining target members of a target user group to be created and displaying a create control in response to a first touch operation on the user ID includes: a user list matching the user ID and a create control are displayed in response to a first touch operation on the user ID, where the user list includes user information of users matching the user ID; and in response to a selection operation on a target user in the user list, the target members of a target user group to be created are determined based on the selection operation.

In one embodiment, the method further includes: the user ID is displayed in the session record in a specified mode that is distinguishable from other contents in the session record in response to the user ID and the specified keyword appearing in the session record.

In one embodiment, the specified mode includes at least one of the following: a highlighting display mode; a display mode of a target color; and an underlining display mode.

In one embodiment, the displaying a user list matching the user ID in response to a first touch operation on the user ID includes: a preset database is searched for users matching the user ID and the found users are displayed in the user list in response to the first touch operation on the user ID, where the preset database contains user IDs and user information of users related to the users in the current user group.

In one embodiment, the searching a preset database for users matching the user ID and displaying the found users in the user list includes: a preset database is searched for users matching the user ID to obtain multiple matching users; the matching users are sorted according to the degree of matching between the matching users and the user corresponding to the session record; and the matching users are displayed in the user list based on the sorting result.

In one embodiment, the current user group includes two members or more than three members.

In one embodiment, the determining target members of a target user group to be created in response to a first touch operation on the user ID includes: the user corresponding to the user ID and the members in the current user group are determined as the target members in response to the first touch operation on the user ID.

In one embodiment, the creating the target user group including the target members in response to a second touch operation on the create control includes: the user corresponding to the user ID is invited to join the current user group to obtain the target user group including the target members in response to a second touch operation on the create control; or a new target user group including the target members is created in response to a second touch operation on the create control.

In one embodiment, the first touch operation includes a drag operation, and the determining target members of a target user group to be created in response to a first touch operation on the user ID includes: a user corresponding to a user symbol where a contact point of a drag operation in the graphical user interface passes and the user corresponding to the user ID are determined as target members of the target user group to be created in response to the drag operation on the user ID.

In one embodiment, the determining a user corresponding to a user symbol where a contact point of a drag operation in the graphical user interface passes and the user corresponding to the user ID as target members of the target user group to be created in response to the drag operation on the user ID includes: a user corresponding to a user symbol where a contact point of a drag operation in the graphical user interface passes is determined in response to the drag operation on the user ID; and the user corresponding to the user symbol where the contact point of the drag operation in the graphical user interface passes and the user corresponding to the user ID are determined as target members of the target user group to be created in response to the end of the drag operation.

In one embodiment, the user symbol is a user avatar.

In one embodiment, the method further includes: the session record in the session window is controlled to scroll when the touch point of the drag operation in the graphical user interface reaches an edge of the session window.

In one embodiment, the determining target members of a target user group to be created in response to a first touch operation on the user ID includes: users corresponding respectively to a session record in a preset range of the session record where the user ID is are determined as target members of the target user group to be created in response to the first touch operation on the user ID.

In one embodiment, the method further includes: modified target members are obtained in response to a modification operation on the determined target members; and the creating the target user group including the target members in response to a second touch operation on the create control includes: the target user group including the modified target members is created in response to a second touch operation on the create control.

Further, the electronic device shown in FIG. 8 includes a bus 102 and a communication interface 103, and the processor 101, the communication interface 103 and the memory 100 are connected via the bus 102.

The memory 100 may include a high-speed random access memory (RAM), and may also include a non-volatile memory, e.g., at least one disk memory. Communication connection between a system network element and at least one other network element is realized through the at least one communication interface 103 (wired or wireless), and the Internet, wide area network, local area network, metropolitan area network, and the like may be used. The bus 102 may be an ISA bus, PCI bus, EISA bus, or the like. The bus may be divided into an address bus, data bus, control bus, and the like. For ease of representation, FIG. 8 shows only one bidirectional arrow, but it does not mean that only one bus or one type of bus is provided.

The processor 101 may be an integrated circuit chip having a signal processing capacity. In an implementation process, the steps of the aforementioned method may be implemented by an integrated logic circuit of hardware or by instructions in software in the processor 101. The processor 101 may be a general-purpose processor such as a central processing unit (CPU) and network processor (NP), digital signal processor (DSP), application specific integrated circuit (ASIC), field-programmable gate array (FPGA), or other programmable logic devices, discrete gates, transistor logic devices, or discrete hardware components, which may implement or execute the methods, steps and logic diagrams disclosed in the embodiments of the present disclosure. The general-purpose processor may be a microprocessor, or the processor may be any conventional processor or the like. The steps of the methods disclosed in the embodiments of the present disclosure may be directly implemented as being executed by a hardware decoding processor, or may be implemented as being executed by a combination of hardware and software modules in a decoding processor. A software module may be located in a random access memory, flash memory, read-only memory, programmable read-only memory, electrically erasable programmable memory, register, or other mature storage media in the art. The storage medium is located in the memory 100, and the processor 101 reads information in the memory 100 and implements the steps of the methods in the aforementioned embodiments in combination with hardware.

An embodiment of the present disclosure further provides a computer-readable storage medium, where computer-executable instructions are stored in the computer-readable storage medium, and the computer-executable instructions, when called and executed by a processor, cause the processor to implement the method for generating a user group, the specific implementation of which is as described in the method embodiment and the descriptions thereof are omitted herein.

Specifically, a graphical user interface is provided via a terminal device, the graphical user interface includes a session window, and the session window displays a session record of users in the current user group; the method including: a user ID is set to be in an interactive state in response to the user ID and a specified keyword appearing in the session record, where the specified keyword indicates generation of a user group related to the user ID; target members of a target user group to be created are determined and a create control is displayed in response to a first touch operation on the user ID, where the target members of the target user group at least include a user corresponding to the user ID; and the target user group including the target members is created in response to a second touch operation on the create control.

By the method for generating a user group, a user corresponding to a user ID can be invited and a new user group can be created or the user can be invited to join the current user group based on the user ID and a specified keyword appearing in a session record in the current session window, so that a new user group can be created or a user can be invited to join a user group without repeatedly switching between sessions. Also, the method does not require manual search for a user, and a user can be quickly matched with a user ID, making the operation for generating a user group quick and simple, and helping improve the user experience.

In one embodiment, the determining target members of a target user group to be created and displaying a create control in response to a first touch operation on the user ID includes: a user list matching the user ID and a create control are displayed in response to a first touch operation on the user ID, where the user list includes user information of users matching the user ID; and in response to a selection operation on a target user in the user list, the target members of a target user group to be created are determined based on the selection operation.

In one embodiment, the method further includes: the user ID is displayed in the session record in a specified mode that is distinguishable from other contents in the session record in response to the user ID and the specified keyword appearing in the session record.

In one embodiment, the specified mode includes at least one of the following: a highlighting display mode; a display mode of a target color; and an underlining display mode.

In one embodiment, the displaying a user list matching the user ID in response to a first touch operation on the user ID includes: a preset database is searched for users matching the user ID and the found users are displayed in the user list in response to the first touch operation on the user ID, where the preset database contains user IDs and user information of users related to the users in the current user group.

In one embodiment, the searching a preset database for users matching the user ID and displaying the found users in the user list includes: a preset database is searched for users matching the user ID to obtain multiple matching users; the matching users are sorted according to the degree of matching between the matching users and the user corresponding to the session record; and the matching users are displayed in the user list based on the sorting result.

In one embodiment, the current user group includes two members or more than three members.

In one embodiment, the determining target members of a target user group to be created in response to a first touch operation on the user ID includes: the user corresponding to the user ID and the members in the current user group are determined as the target members in response to the first touch operation on the user ID.

In one embodiment, the creating the target user group including the target members in response to a second touch operation on the create control includes: the user corresponding to the user ID is invited to join the current user group to obtain the target user group including the target members in response to a second touch operation on the create control; or a new target user group including the target members is created in response to a second touch operation on the create control.

In one embodiment, the first touch operation includes a drag operation, and the determining target members of a target user group to be created in response to a first touch operation on the user ID includes: a user corresponding to a user symbol where a contact point of a drag operation in the graphical user interface passes and the user corresponding to the user ID are determined as target members of the target user group to be created in response to the drag operation on the user ID.

In one embodiment, the determining a user corresponding to a user symbol where a contact point of a drag operation in the graphical user interface passes and the user corresponding to the user ID as target members of the target user group to be created in response to the drag operation on the user ID includes: a user corresponding to a user symbol where a contact point of a drag operation in the graphical user interface passes is determined in response to the drag operation on the user ID; and the user corresponding to the user symbol where the contact point of the drag operation in the graphical user interface passes and the user corresponding to the user ID are determined as target members of the target user group to be created in response to the end of the drag operation.

In one embodiment, the user symbol is a user avatar.

In one embodiment, the method further includes: the session record in the session window is controlled to scroll when the touch point of the drag operation in the graphical user interface reaches an edge of the session window.

In one embodiment, the determining target members of a target user group to be created in response to a first touch operation on the user ID includes: users corresponding respectively to a session record in a preset range of the session record where the user ID is are determined as target members of the target user group to be created in response to the first touch operation on the user ID.

In one embodiment, the method further includes: modified target members are obtained in response to a modification operation on the determined target members; and the creating the target user group including the target members in response to a second touch operation on the create control includes: the target user group including the modified target members is created in response to a second touch operation on the create control.

When implemented in the form of a software functional unit and sold or used as an independent product, the function may be stored in a computer-readable storage medium. Based on such an understanding, the technical solutions, or part that contributes to the related art, or part of the technical solutions of the present disclosure, may be embodied in the form of a software product, where the computer software product is stored in a storage medium and includes a number of instructions for enabling a computer device (which may be a personal computer, terminal device, network device, or the like) to execute all or part of the steps of the methods in the embodiments of the present disclosure. The aforementioned storage medium includes: a USB flash disk, mobile hard disk, read-only memory (ROM), random access memory (RAM), magnetic disk, optical disk, or any other media capable of storing program codes.

It should be noted that the above embodiments are only specific implementations of the present disclosure, and are used for illustrating the technical solutions of the present disclosure rather than limiting the present disclosure. The protection scope of the present disclosure is not limited thereto. Although the present disclosure is described in detail with reference to the aforementioned embodiments, those of ordinary skill in the art should understand that within the technical scope disclosed in the present disclosure, those skilled in and familiar with the art may still modify the technical solutions recorded in the aforementioned embodiments, or make equivalent replacements for some of the technical features therein; and these modifications, changes or replacements do not deviate the essence of the corresponding technical solutions from the spirit and scope of the technical solutions of the embodiments of the present disclosure, and should all be covered by the protection scope of the present disclosure. Therefore, the protection scope of the present disclosure should be based on the protection scope of the claims.

1. A method for generating a user group, comprising:
setting, in response to a user ID and a keyword appearing in a session record of a current user group, the user ID to be in an interactive state, wherein the session record of the current user group is displayed in a session window within a graphic user interface of a terminal device, and the keyword indicates an intent to generate a target user group related to the user ID;
determining, in response to a first touch operation on the user ID, a target member of the target user group, wherein the target member of the target user group comprises a user matching the user ID;
displaying a create control; and
creating the target user group comprising the target member in response to a second touch operation on the create control.

2. The method according to claim 1, wherein determining the target member of the target user group in response to the first touch operation on the user ID comprises:
displaying, in response to the first touch operation on the user ID, a user list matching the user ID and the create control, wherein the user list comprises information of the user matching the user ID; and
determining, in response to a selection operation on a target user in the user list, the target member of the target user group based on the selection operation.

3. The method according to claim 1, further comprising:
displaying, in response to the user ID and the keyword appearing in the session record, the user ID in the session record in a mode that is distinguishable from other contents in the session record.

4. The method according to claim 3, wherein the mode comprises at least one of a highlighting display mode, a display mode of a target color, and an underlining display mode.

5. The method according to claim 2, wherein displaying the user list matching the user ID in response to the first touch operation on the user ID comprises:
searching a preset database for the user matching the user ID or users with IDs similar to the user ID; and
displaying one or more found users in the user list in response to the first touch operation on the user ID,
wherein the preset database comprises user IDs and information for one or more users in the current user group.

6. The method according to claim 5, wherein displaying the one or more found users in the user list comprises:
sorting the one or more found users according to a degree of matching between the one or more found users and a user corresponding to the session record; and
displaying the one or more found users in the user list based on the sorting result.

7. The method according to claim 1, wherein the current user group comprises at least two members.

8. The method according to claim 1, wherein determining the target member of the target user group in response to the first touch operation on the user ID comprises:
determining the user matching the user ID or a member in the current user group as the target member in response to the first touch operation on the user ID.

9. The method according to claim 1, wherein creating the target user group comprising the target member in response to the second touch operation on the create control comprises:
inviting the user matching the user ID to join the current user group to obtain the target user group comprising the target member in response to the second touch operation on the create control; or
creating a new target user group comprising the target member in response to the second touch operation on the create control.

10. The method according to claim 1, wherein the first touch operation comprises a drag operation, and determining the target member of the target user group in response to the first touch operation on the user ID comprises:
determining, in response to the drag operation on the user ID, the target member of the target user group comprising a user corresponding to a user symbol or the user matching the user ID, wherein a contact point of the drag operation in the graphical user interface passes over the user symbol.

11. The method according to claim 10, wherein determining the target member of the target user group comprising the user corresponding to the user symbol or the user matching the user ID in response to the drag operation on the user ID comprises:
determining the user corresponding to the user symbol in response to the drag operation on the user ID; and
determining the user corresponding to the user symbol or the user matching the user ID as the target member of the target user group in response to an end of the drag operation.

12. The method according to claim 10, wherein the user symbol comprises a user avatar.

13. The method according to claim 10, further comprising:
controlling the session record in the session window to scroll when the contact point of the drag operation in the graphical user interface reaches an edge of the session window.

14. The method according to claim 1, wherein determining the target member of the target user group in response to the first touch operation on the user ID comprises:
determining, in response to the first touch operation on the user ID, a user corresponding respectively to a session record in a preset range of the session record comprising the user ID as the target member of the target user group.

15. The method according to claim 14, further comprising:
obtaining a modified target member in response to a modification operation on the target member,
wherein creating the target user group comprising the target member in response to the second touch operation on the create control comprises:
creating the target user group comprising the modified target member in response to the second touch operation on the create control.

16. (canceled)

17. A system, comprising:
one or more memories collectively containing one or more programs; and
one or more processors, wherein the one or more processors are configured to, individually or collectively, perform an operation comprising:
setting, in response to a user ID and a keyword appearing in a session record of a current user group, the user ID to be in an interactive state, wherein the session record of the current user group is displayed in a session window within a graphic user interface of a terminal device, and the keyword indicates an intent to generate a target user group related to the user ID;
determining, in response to a first touch operation on the user ID, a target member of the target user group, wherein the target member of the target user group comprises a user matching the user ID;
displaying a create control; and
creating the target user group comprising the target member in response to a second touch operation on the create control.

18. One or more non-transitory computer-readable storage media containing, in any combination, computer program code that, when executed by a computer system, perform an operation comprising:
setting, in response to a user ID and a keyword appearing in a session record of a current user group, the user ID to be in an interactive state, wherein the session record of the current user group is displayed in a session window within a graphic user interface of a terminal device, and the keyword indicates an intent to generate a target user group related to the user ID;
determining, in response to a first touch operation on the user ID, a target member of the target user group, wherein the target member of the target user group comprises a user matching the user ID;
displaying a create control; and
creating the target user group comprising the target member in response to a second touch operation on the create control.

19. The system according to claim 17, wherein determining the target member of the target user group in response to the first touch operation on the user ID comprises:
displaying, in response to the first touch operation on the user ID, a user list matching the user ID and the create control, wherein the user list comprises information of the user matching the user ID; and
determining, in response to a selection operation on a target user in the user list, the target member of the target user group based on the selection operation.

20. The system according to claim 17, wherein creating the target user group comprising the target member in response to the second touch operation on the create control comprises:
inviting the user matching the user ID to join the current user group to obtain the target user group comprising the target member in response to the second touch operation on the create control; or
creating a new target user group comprising the target member in response to the second touch operation on the create control.

21. The system according to claim 17, wherein the first touch operation comprises a drag operation, and determining the target member of the target user group in response to the first touch operation on the user ID comprises:
determining, in response to the drag operation on the user ID, the target member of the target user group comprising a user corresponding to a user symbol or the user matching the user ID, wherein a contact point of the drag operation in the graphical user interface passes over the user symbol.
